(19) United States
(12) Patent Application Publication
(10) Pub. No.: US 2021/0055214 A1
(43) Pub. Date: Feb. 25, 2021

(54) GAS ANALYZER

(71) Applicant: YOKOGAWA ELECTRIC CORPORATION, Tokyo (JP)

(72) Inventors: Yusaku Umino, Tokyo (JP); Phillip Proctor, Sugar Land, TX (US)

(73) Assignee: YOKOGAWA ELECTRIC CORPORATION, Tokyo (JP)

(21) Appl. No.: 16/921,022

(22) Filed: Jul. 6, 2020

(30) Foreign Application Priority Data
Aug. 19, 2019 (JP) 2019-149998

(51) Int. Cl. G01N 21/39; G01K 7/16; G01K 7/02; F24H 3/08

(52) U.S. Cl. CPC G01N 21/39; G01K 7/16; G01K 7/02; G01N 2201/0636; G01N 2021/399; G01N 2201/0612; F24H 3/08

(57) ABSTRACT

A gas analyzer for measuring predetermined components in a measurement gas introduced into a measurement cell by irradiating the measurement gas with a light from a light emitter and receiving the light that passed through the measurement gas using a light receiver includes: a double tube including an inner tube that is part of the measurement cell and an outer tube surrounding the inner tube. The measurement gas is introduced into the double tube from between the inner tube and the outer tube.

### TECHNICAL FIELD

The present invention relates to a gas analyzer.

### BACKGROUND

A gas analyzer for measuring predetermined components in a measurement gas by irradiating, with a light, the measurement gas introduced into a measurement cell and receiving the light passing through the measurement gas is known (for example, see patent document 1). Such a gas analyzer may be configured such that piping is connected to a measurement gas inlet penetrating a tube constituting a measurement cell and that the measurement gas is introduced into the measurement cell through the piping.

### PATENT DOCUMENTS

[Patent Document 1] JP 2010-236877 A

However, when configuring as above, when the ambient temperature changes, the temperature of the measurement gas within the measurement cell changes due to the influence thereof, and as a result, there is a risk that measurement precision of predetermined components in the measurement gas will be affected.

### SUMMARY

One or more embodiments of the present invention provide a gas analyzer capable of mitigating the influence of ambient temperature changes on the temperature of a measurement gas within a measurement cell and therefore capable of improving measurement precision.

A gas analyzer according to one or more embodiments is a gas analyzer for measuring predetermined components in a measurement gas by irradiating, with a light, the measurement gas introduced into a measurement cell and receiving the light passing through the measurement gas, configured from an inner tube constituting the measurement cell and an outer tube surrounding the inner tube, and having a double tube through which the measurement gas is introduced into the inner tube between the inner tube and the outer tube. According to such a configuration, the space between the inner tube and the outer tube can be used not only as a flow path for introducing the measurement gas into the inner tube, but also as a heat insulating layer. Accordingly, it is possible to mitigate the influence of ambient temperature changes on the temperature of a measurement gas within a measurement cell, and thereby it is possible to improve measurement precision.

In one or more embodiments, the gas analyzer may have a temperature adjuster (i.e., heater) for adjusting the temperature of the double tube. According to such a configuration, as it is possible to efficiently adjust the temperature of the measurement gas before it is introduced into the inner tube, it is possible to make the temperature of the measurement gas within the inner tube more uniform, and thereby it is possible to further improve measurement precision.

In one or more embodiments, the temperature adjuster of the gas analyzer may have a heat insulating member (i.e., heat insulator) disposed on an outer peripheral surface of the outer peripheral pipe. According to such a configuration, it is possible to more efficiently adjust the temperature of the measurement gas before it is introduced into the inner tube.

In one or more embodiments, in the foregoing configuration, the gas analyzer may have the heat insulating member wound on the outer peripheral surface of the outer tube in a coil shape. According to such a configuration, it is possible to even more efficiently adjust the temperature of the measurement gas before it is introduced into the inner tube.

In one or more embodiments, in the foregoing configuration, the gas analyzer may have a heat insulating member surrounding the outer tube. According to such a configuration, it is possible to mitigate the influence of ambient temperature changes on the temperature of the measurement gas within the measurement cell.

In one or more embodiments, in the foregoing configuration, the measurement cell of the gas analyzer may be provided with a reflector for reflecting light and have an end member (i.e., end piece) located at one axial end part of the double tube. According to such a configuration, it is possible to enable size reduction of the gas analyzer due to a simple configuration.

In one or more embodiments, in the foregoing configuration, the end member of the gas analyzer may have an inflow port for allowing the measurement gas to flow into a back side of the reflector from between the inner tube and the outer tube, an outflow port for allowing the measurement gas to flow into the inner tube from the back side of the reflector, and a temperature sensor disposed on the back side of the reflector. According to such a configuration, using the temperature sensor, the temperature of the measurement gas can be directly measured near the measurement cell without obstructing the path of light, and it can be used for measurement of predetermined components in the measurement gas. Furthermore, by providing not only an inflow port, but also an outflow port, it is possible to control gas retention within the end member, and thus it is possible to make the distribution of predetermined components in the measurement gas within the measurement cell more uniform. Accordingly, it is possible to further improve measurement precision.

In one or more embodiments, in the foregoing configuration, the temperature adjuster of the gas analyzer may be configured so as to adjust the temperature of the double tube based on a value measured by the temperature sensor disposed on the back side of the reflector. According to such a configuration, by adjusting the temperature of the double tube, it is possible to precisely adjust the temperature of the measurement gas within the measurement cell.

In one or more embodiments, in the foregoing configuration, one axial end part of the double tube of the gas analyzer may form an introduction port for introducing the measurement gas into the inner tube from between the inner tube and the outer tube. According to such a configuration, as it is possible to smoothly introduce the measurement gas into the inner tube from the introduction port, it is possible to make the temperature distribution of the measurement gas within the measurement cell more uniform, and thereby it is possible to further improve measurement precision.

In one or more embodiments, in the foregoing configuration, the gas analyzer may be a laser gas analyzer using tunable diode laser absorption spectroscopy. According to such a configuration, it is possible to enable highly precise measurement using tunable diode laser absorption spectroscopy.

According to one or more embodiments of the present invention, it is possible to provide a gas analyzer capable of mitigating the influence of ambient temperature changes on the temperature of a measurement gas within a measurement cell and therefore capable of improving measurement precision.

### BRIEF DESCRIPTION OF DRAWINGS

FIG. 1 is a planar view illustrating a gas analyzer according to one or more embodiments.

FIG. 2 is a cross-sectional view illustrating a portion of the gas analyzer illustrated in FIG. 1.

### DETAILED DESCRIPTION

Embodiments of the present invention will be exemplified and described in detail below with reference to drawings.

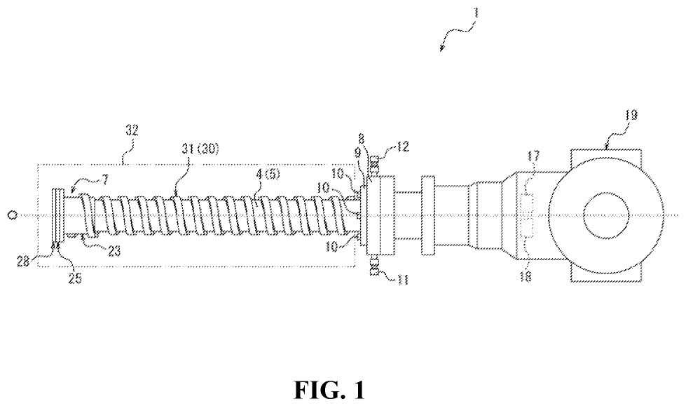

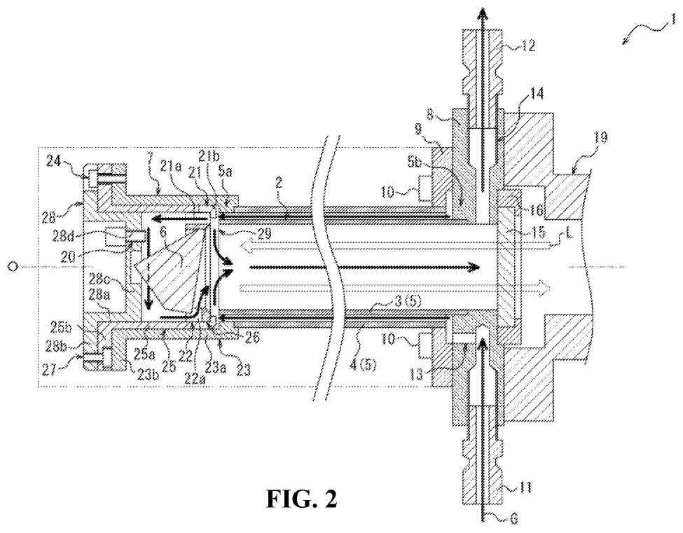

As illustrated in FIG. 1 and FIG. 2, a gas analyzer 1 according to one or more embodiments is, for example, configured to measure predetermined components in a measurement gas G using tunable diode laser absorption spectroscopy (TDLAS: tunable diode laser absorption spectroscopy) by irradiating, with a light L, the measurement gas G introduced into a measurement cell 2 and receiving the light L passing through the measurement gas G.

The gas analyzer 1 is configured from an inner tube 3 constituting the measurement cell 2 and an outer tube 4 surrounding the inner tube 3. The inner tube 3 and outer tube 4 form a double tube 5 through which the measurement gas G is introduced into the inner tube 3 between the inner tube 3 and the outer tube 4. The inner tube 3 and the outer tube 4 are each, for example, cylindrical. The inner tube 3 and the outer tube 4 are disposed concentrically. That is, the inner tube 3 and the outer tube 4 have a common central axis O. Note, the inner tube 3 and the outer tube 4 may be disposed eccentrically.

Furthermore, the measurement cell 2 is provided with a reflector 6 for reflecting the light L and has an end member 7 located at one axial end part 5a of the double tube 5. The reflector 6 is a retroreflector, but it is not limited thereto. Note, in one or more embodiments, the axial direction of the double tube 5 (hereinafter, also simply referred to as axial direction) means the direction along the central axis O. Furthermore, in one or more embodiments, a side on which the one axial end part 5a of the double tube 5 is located with respect to another axial end part 5b of the double tube 5 (that is, the left side in FIG. 2) is referred to as the one axial end side, and a side opposite thereto is referred to as the other axial end side.

In the other axial end part 5b of the double tube 5, an inner tube flange 8 is connected to the inner tube 3 by, for example, welding, and an outer tube flange 9 is connected to the outer tube 4 by, for example, welding. The outer tube flange 9 is connected to the inner tube flange 8 by a connector 10. Note, the connector 10 is a bolt, but it is not limited thereto. It may be a fastener other than a bolt, and it may be a connector other than a fastener. Furthermore, these may be connected by means other than the connector 10, for example, welding or the like. However, it is preferable to configure such that the outer tube 4 can be attached to and detached from the inner tube 3 by attaching and detaching the connector 10 as a fastener. According to such a configuration, it is possible to easily maintain a flow path between the inner tube 3 and the outer tube 4 when dirtied with dust, condensation, or the like.

A supply plug 11 for passing the measurement gas G toward the measurement cell 2 and a discharge plug 12 for passing the measurement gas G discharged from the measurement cell 2 are mounted on the inner tube flange 8. Furthermore, a supply path 13 for allowing the measurement gas G to flow from the supply plug 11 to between the inner tube 3 and the outer tube 4 is formed by a hollow portion provided in the inner tube flange 8 and an annular groove provided in the outer tube flange 9, centered around the central axis O. Moreover, a discharge path 14 for allowing the measurement gas G to flow from between the inner tube 3 and the outer tube 4 to the discharge plug 12 is formed by a hollow portion provided in the inner tube flange 8. Note, the supply path for supplying the measurement gas G to between the inner tube 3 and the outer tube 4 and the discharge path for discharging the measurement gas G from between the inner tube 3 and the outer tube 4 are not limited to the foregoing configuration and can be designed as appropriate.

The end part on the other axial end side of the measurement cell 2 is configured by a window 15 mounted on the inner tube flange 8. The window 15 is formed from a material that transmits the light L but does not transmit the measurement gas G. Further, the window 15 is connected to an end face on the other axial end side of the inner tube flange 8 by a frame member 16 connected to the inner tube flange 8 by, for example, a connector. Note, the configuration of the end part on the other axial end side of the measurement cell 2 is not limited thereto and can be designed as appropriate. As described above, in one or more embodiments, the measurement cell 2 is configured from the inner tube 3, the end member 7 (more specifically, the reflector 6, a frame 26 described later, and a middle member 25 described later), the inner tube flange 8, and the window 15. Note, a sealing material such as an O-ring is disposed between the members constituting the measurement cell 2 and the like as appropriate, but the illustration is omitted.

The gas analyzer 1 has an analyzer console 19 provided with a light emitting part 17 (i.e., light emitter) for irradiating the light L and a light receiving part 18 (i.e., light receiver) for receiving the light L. For example, the analyzer console 19 can measure, for example, the concentration of a predetermined component in the measurement gas G based on a difference in intensity of a component of a specific wavelength between the light L emitted by the light emitting part 17 and the light L received by the light receiving part 18, that is, absorbance, an optical path length of the light L within the measurement cell 2, the temperature of the measurement gas G within the measurement cell 2, and the like. Examples of the predetermined component include CO, CO₂, H₂O, CₙHₘ, NH₃, O₂, and the like. The end part on the one axial end side of the analyzer console 19 is connected to the inner tube flange 8 by, for example, a connector.

As indicated by the outlined arrow in FIG. 2, the light L emitted from the light emitting part 17 passes through the window 15, proceeds through the inside of the measurement cell 2 from the other axial end side to the one axial end side, is reflected by the reflector 6, proceeds through the inside of the measurement cell 2 from the one axial end side to the other axial end side, passes through the window 15, and is received by the light receiving part 18.

Note, the gas analyzer 1 is not limited to having the reflector 6 as above and, for example, may be configured such that the light emitting part 17 and the light receiving part 18 are disposed sandwiching the measurement cell 2 in the axial direction.

In order to precisely measure, for example, the concentration of the predetermined component in the measurement gas G, it is preferable to directly measure the temperature of the measurement gas G near the measurement cell 2. Thus, in one or more embodiments, along with disposing a temperature sensor 20 on a back side of the reflector 6, the end member 7 is provided with an inflow port 21 for allowing the measurement gas G to flow from between the inner tube 3 and the outer tube 4 into the back side of the reflector 6 and an outflow port 22 for allowing the measurement gas G to flow out from the back side of the reflector 6 into the inner tube 3. The temperature sensor 20 may be configured from, for example, a resistance temperature detector or a thermocouple.

The end member 7 has an outer member 23 connected to the end portion on the one axial end side of the outer tube 4 by, for example, welding; a middle member 25 connected to the outer member 23 by a connector 24; a frame 26 connected to the middle member 25 by, for example, fitting; and an inner member 28 connected to the middle member 25 by a connector 27. Note, the end member 7 is not limited to such a member configuration.

The outer member 23 has an outer cylinder 23a and an outer flange 23b extending radially outward from the end on the one axial end side of the outer cylinder 23a. The middle member 25 has a middle cylinder 25a and a middle flange 25b extending radially outward from the end on the one axial end side of the middle cylinder 25a. The inner member 28 has an inner cylinder 28a, an inner flange 28b extending radially outward from the end on the one axial end side of the inner cylinder 28a, and an end part wall 28c extending radially inward from the end on the other axial end side of the inner cylinder 28a. An outer peripheral surface of the middle cylinder 25a contacts an inner peripheral surface of the outer cylinder 23a, and an outer peripheral surface of the inner cylinder 28a contacts an inner peripheral surface of the middle cylinder 25a. The outer flange 23b and the middle flange 25b are connected by the connector 24, and the middle flange 25b and the inner flange 28b are connected by the connector 27. Note, the connectors 24 and 27 are each a bolt, but they are not limited thereto. They may be fasteners other than bolts, and they may be connectors other than fasteners. Furthermore, these may be connected by means other than the connectors 24 and 27, for example, welding or the like. However, it is preferable to configure such that a unit configured from the middle member 25, the inner member 28, the frame 26, the reflector 6, and the temperature sensor 20 can be attached to and detached from the outer member 23 by attaching and detaching the connector 24 as a fastener. According to such a configuration, it is possible to easily perform maintenance for removing dust and the like adhering to and accumulating on the reflector 6, which hinders measurement.

The frame 26 is connected to the reflector 6 and holds the reflector 6. The inflow port 21 is formed by a notch part 21a provided on the outer peripheral surface of the frame 26 in the axial direction and a notch 21b provided at the end part on the other axial end side of the middle cylinder 25a. Furthermore, the outflow port 22 is formed by the notch part 22a provided at the end part on the one axial end side of the frame 26. Note, the configuration of the inlet port 21 and the outlet port 22 is not limited thereto. The temperature sensor 20 is mounted on a mounting port 28d penetrating the end part wall 28c. Note, the arrangement of the temperature sensor 20 is not limited thereto. For example, a hole part may be provided penetrating the outer cylinder 23a and the middle cylinder 25a, and the temperature sensor 20 may be disposed in the hole part. However, in this case, it becomes necessary to go through a process of attaching and detaching the temperature sensor 20 to and from the end member 7 when attaching and detaching the unit configured from the middle member 25, the inner member 28, the frame 26, and the reflector 6 to and from the outer member 23 for maintenance of the reflector 6. Accordingly, it is preferable to dispose the temperature sensor 20 on a mounting port 28d provided on the end part wall 28c.

The one axial end part 5a of the double tube 5 forms an introduction port 29 for introducing the measurement gas G from between the inner tube 3 and the outer tube 4 into the inner tube 3. The introduction port 29 is configured from a gap between the inner tube 3 and the end part on the other axial end side of the middle cylinder 25a, but it is not limited thereto. Furthermore, one or more embodiments are configured to directly introduce the measurement gas G from between the inner tube 3 and the outer tube 4 into the inner tube 3 via the introduction port 29, but it is not limited thereto.

The measurement gas G flows into the supply path 13 through the supply plug 11, passes between the inner tube 3 and the outer tube 4, and at the one axial end part 5a of the double tube 5, splits into a stream flowing into the inner tube 3 via the introduction port 29 and a stream flowing into the back side of the reflector 6 via the inlet port 21 of the end member 7. The measurement gas G flowing into the back side of the reflector 6 flows into the inner tube 3 via the outlet port 22. The measurement gas G flowing into the inner tube 3 flows through the inside of the inner tube 3 from the one axial end side toward the other axial end side, flows into the discharge path 14, and is discharged through the discharge plug 12.

The gas analyzer 1 has a temperature adjuster 30 for adjusting the temperature of the double tube 5. The temperature adjuster 30 is configured from a heating member 31 disposed on an outer peripheral surface of the outer tube 4, the above-described temperature sensor 20 for directly measuring the temperature of the measurement gas G, and an unillustrated controller for controlling the temperature of the heating member 31 based on a value measured by the temperature sensor 20. The heating member 31 is wound around the outer peripheral surface of the outer tube 4 in a coil shape. The heating member 31 is configured, for example, from an electric heating element such as a heating wire or a heat exchanger such as a fluid tube through which a heating medium flows. Note, illustration of the heating member 31 is omitted in FIG. 2. The temperature adjuster 30 can adjust the temperature of the double tube 5 using the heating member 31, for example, such that the value measured by the temperature sensor 20 becomes a desired target value. The temperature of the double tube 5 is adjusted to a desired temperature, for example, 100° C. or higher.

Note, the arrangement of the temperature sensor 20 is not limited to the back side of the reflector 6 such as described above. For example, the configuration may be such that the temperature sensor 20 is disposed in the inner tube 3 to directly measure the temperature in the measurement cell 2, and the configuration may be such that the temperature sensor 20 is disposed on the outer peripheral surface of the outer tube 4 to indirectly measure the temperature in the measurement cell 2. When disposing the temperature sensor 20 within the inner tube 3, the configuration may be such that a hole part is provided penetrating the double tube 5 in the radial direction and the temperature sensor 20 is disposed in the hole. However, in this case, the double tube 5 ceases to have the double tube structure in the portion where the hole is provided, and thus the function of mitigating the influence of the ambient temperature decreases accordingly. Furthermore, the double tube 5 ceases to have the double tube structure in the portion where the hole is provided, and thus the function of preheating the measurement gas G flowing between the inner tube 3 and the outer tube 4 using the heating member 31 disposed on the outer peripheral surface of the outer tube 4 before being introduced into the inner tube 3 decreases accordingly. Moreover, when configuring such that the temperature sensor 20 is disposed in the foregoing hole part, it becomes necessary to go through a process for attaching and detaching the temperature sensor 20 to and from the double tube 5 when maintaining the flow path between the inner tube 3 and the outer tube 4 by attaching and detaching the outer tube 4 to and from the inner tube 3. Accordingly, it is preferable to dispose the temperature sensor 20 on the back side of the reflector 6.

Note, the configuration may be such that a temperature sensor for directly measuring the temperature of the double tube 5 is provided in place of or in addition to the above-described temperature sensor 20 for directly measuring the temperature of the measurement gas G and the temperature adjuster 30 is configured from this temperature sensor. The heating member 31 is not limited to being coil-shaped. Furthermore, the heating member 31 is not limited to being disposed on the outer peripheral surface of the outer tube 4. The configuration may be such that the temperature adjuster 30 is not provided.

The gas analyzer 1 has a heat insulating member 32 surrounding the outer tube 4, the heating member 31, and the end member 7. Note, illustration of the heat insulating member 32 is omitted in FIG. 2. The heat insulating member 32 can be configured by a desired material, such as inorganic fiber or plastic foam. The heat insulating member 32 is preferably configured to surround the end member 7, but it may be configured to not surround the end member 7. Furthermore, the configuration may be such that the heat insulating member 32 is not provided.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### DESCRIPTION OF REFERENCE NUMERALS

1 Gas analyzer
2 Measurement cell
3 Inner tube
4 Outer tube
5 Double tube
5a One axial end part of double tube
5b Other axial end part of double tube
6 Reflector
7 End member
8 Inner tube flange
9 Outer tube flange
10 Connector
11 Supply plug
12 Discharge plug
13 Supply path
14 Discharge path
15 Window
16 Frame member
17 Light emitting part
18 Light receiving part
19 Analyzer console
20 Temperature sensor
21 Inflow port
21a, 21b Notch part
22 Outflow port
22a Notch part
23 Outer member
23a Outer cylinder
23b Outer flange
24 Fastener
25 Middle member
25a Middle cylinder
25b Middle flange
26 Frame
27 Connector
28 Inner member
28a Inner cylinder
28b Inner flange
28c End part wall
28d Mounting port
29 Introduction port
30 Temperature adjuster
31 Heating member
32 Heat insulating member
G Measurement gas
L Light
O Central axis

What is claimed is:

1. A gas analyzer for measuring predetermined components in a measurement gas introduced into a measurement cell by irradiating the measurement gas with light from a light emitter and receiving the light passing through the measurement gas with a light receiver, the gas analyzer comprising:
a double tube comprising:
an inner tube that is part of the measurement cell; and
an outer tube surrounding the inner tube,
wherein the measurement gas is introduced into the double tube from between the inner tube and the outer tube.

2. The gas analyzer according to claim 1, further comprising:
a heater that adjusts a temperature of the double tube.

3. The gas analyzer according to claim 2, wherein the heater is disposed on an outer peripheral surface of the outer tube.

4. The gas analyzer according to claim 3, wherein the heater is wound around the outer peripheral surface in a coil shape.

5. The gas analyzer according to claim 1, further comprising:
a heat insulator surrounding the outer tube.

6. The gas analyzer according to claim 1, wherein the measurement cell further comprises:
a reflector that reflects the light; and
an end piece disposed at one axial end part of the double tube.

7. The gas analyzer according to claim 6, wherein the end piece further comprises:
an inflow port that the measurement gas flows into from between the inner tube and the outer tube and towards a back side of the reflector;
an outflow port that the measurement gas flows into to exit the end piece into the inner tube from the back side of the reflector; and
a temperature sensor disposed on the back side of the reflector.

8. The gas analyzer according to claim 6, wherein the one axial end part of the double tube is an introduction port where the measurement gas from between the inner tube and the outer tube is introduced into the inner tube.

9. The gas analyzer according to claim 1, wherein the gas analyzer is a laser gas analyzer that uses tunable diode laser absorption spectroscopy.

10. The gas analyzer according to claim 2, wherein the heater is a heating wire.

11. The gas analyzer according to claim 2, wherein the heater is a fluid tube through which a heating medium flows.

12. The gas analyzer according to claim 6, wherein the reflector is a retroreflector.

13. The gas analyzer according to claim 6, wherein the reflector is disposed in the end piece.

14. The gas analyzer according to claim 13, wherein the reflector is disposed between the temperature sensor and the inflow and outflow ports.

15. The gas analyzer according to claim 7, wherein the one axial end part of the double tube is an introduction port where the measurement gas from between the inner tube and the outer tube is introduced into the inner tube.
